(19) United States
(12) Patent Application Publication
(10) Pub. No.: US 2012/0143939 A1
(43) Pub. Date: Jun. 7, 2012

(54) MOBILE NODE AND METHOD FOR MAINTAINING SESSION USING LOGICAL INTERFACE

(75) Inventors: Hyun-Joo KANG, Daejeon-si (KR); Yoon-Young AN, Daejeon-si (KR); Boo-Geum JUNG, Daejeon-si (KR); Byung-Jun AHN, Daejeon-si (KR)

(73) Assignee: Electronics and Telecommunications Research Institute, Daejeon (KR)

(21) Appl. No.: 13/309,197

(22) Filed: Dec. 1, 2011

(30) Foreign Application Priority Data
Dec. 2, 2010 (KR) 10-2010-0122180

(51) Int. Cl. G06F 15/16; H04W 8/00

(52) U.S. Cl. 709/201

(57) ABSTRACT

A mobile node and method suitable to allocate a single Internet protocol (IP) address to a physically independent interface and to provide a logical interface that connects between an application layer and the physical interface are provided. The mobile node includes an upper layer processing unit configured to perform a packet service; a physical interface unit configured to comprise multiple physical interfaces for access to multiple wireless networks; and a logical interface unit configured to allocate a single home IP address to the multiple physical interfaces and enable the upper layer processing unit to process a packet using the single home IP address, and to process packets belonging to the same session to be transmitted and received through the same physical interface from among the multiple physical interfaces.

### CROSS-REFERENCE TO RELATED APPLICATION(S)

This application claims the benefit under 35 U.S.C. §119(a) of Korean Patent Application No. 10-2010-0122180, filed on Dec. 2, 2010, in the Korean Intellectual Property Office, the entire disclosure of which is incorporated herein by reference for all purposes.

### BACKGROUND

1. Field

The following description relates to a technology for mobility of a mobile including multiple physical interfaces accessible to multiple access networks.

2. Description of the Related Art

In the current Internet network technology, as identifier information and location information of a terminal, an Internet protocol (IP) address is assigned to a network interface (NIC) card one by one. That is, an interface of a terminal accessible to a particular access network is assigned an address that has been assigned by an Internet service provider (ISP). However, to provide mobility between networks of different access schemes, like a home address of a mobile IP protocol, a single IP address should be used regardless of a location of a terminal. In other words, through the combination of a home address and a care of address (CoA) a current location of a mobile node is updated in a home agent (HA), thereby enabling a correspondent node (CN) to communicate with the mobile node. By such a method, an application session between nodes can be maintained and thus seamless handover can be achieved.

However, a mobile IP technology which involves with mobility based on a terminal is complex in configuration, and requires a large amount of processing capacity to be mounted on a terminal. Therefore, network-based mobility technologies have been actively researched. The technologies for providing network-based mobility include proxy mobile IP (PMIP) protocol. PMIP protocol is to manage mobility between a local mobile anchor (LMA) and a mobile access gateway (MAG), wherein the LMA localizes a home agent function of mobile IP protocol and the MAG substitutes for a mobile node function in a network. Hence, although a mobile node does not need to employ a technology for supporting mobility, a particular function for handover should be implemented in a network apparatus.

### SUMMARY

The following description relates to a mobile node and method suitable to allocate a single Internet protocol (IP) address to a physically independent interface and to provide a logical interface that connects between an application layer and the physical interface.

In one general aspect, there is provided a mobile node including: an upper layer processing unit configured to perform a packet service; a physical interface unit configured to comprise multiple physical interfaces for access to multiple wireless networks; and a logical interface unit configured to allocate a single home Internet protocol (IP) address to the multiple physical interfaces and enable the upper layer processing unit to process a packet using the single home IP address, and to process packets belonging to the same session to be transmitted and received through the same physical interface from among the multiple physical interfaces.

In another general aspect, there is provided a packet processing method including: transferring, at an upper layer processing unit, a packet to a logical interface unit using a single home IP address; searching for, at the logical interface unit, physical interface information regarding a destination address of the transferred packet from the session mapping table that includes session mapping information indicating a mapping relationship of each session to physical interfaces; and when the physical interface information regarding the destination address of the transferred packet is found, transmitting the packet through a physical interface corresponding to the found physical interface information from among multiple physical interfaces for access to multiple wireless networks.

In another general aspect, there is provided a packet processing method including: receiving a packet through one of multiple physical interfaces for access to multiple wireless networks wherein the packet has a single home IP address allocated to the multiple physical interfaces as a destination address; transferring the received packet from the physical interface to a logical interface having the single home IP address; searching for, at the logical interface unit, physical interface information regarding a source address of the transferred packet from session mapping table that includes session mapping information indicating a mapping relationship of each session to the physical interfaces; and when the physical interface information regarding the source address of the transferred packet is found, transferring the transferred packet to an upper layer processing unit that performs a packet service.

Other features and aspects may be apparent from the following detailed description, the drawings, and the claims.

### BRIEF DESCRIPTION OF THE DRAWINGS

FIG. 1 is a diagram illustrating an example of a mobile node and network connection using a logical interface of the mobile node.

FIG. 2 shows tables illustrating an example of a session mapping table.

FIG. 3 is a table illustrating an example of an application policy profile table.

FIG. 4 is a flowchart illustrating an example of procedures of processing a packet transferred from an upper layer processing unit that executes an application.

FIG. 5 is a flowchart illustrating an example of procedures to be processed by a logical interface for a packet received through a physical interface from a correspondent node.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

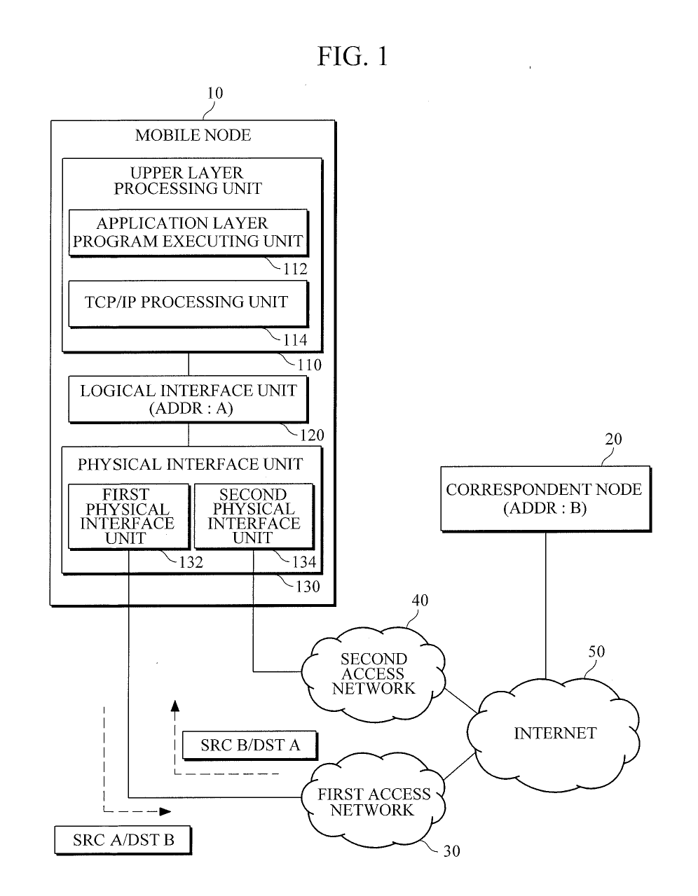

FIG. 1 illustrates a diagram of an example of a mobile node and network connection using a logical interface of the mobile node.

Referring to FIG. 1, the mobile node 10 may be connected to multiple access networks 30 and 40, and a correspondent node 20 through the Internet 50. The mobile node 10 may be a mobile phone, a smart phone, a personal computer, a laptop computer, and the like. The correspondent node 20 may be the same type as the mobile node 10, or a server.

The mobile node 10 may be a multi-mode mobile node configured to be accessible to the multiple access networks 30 and 40. The mobile node 10 may include an upper layer processing unit 110, a logical interface unit 120, and a physical interface unit 130.

The upper layer processing unit 110 may process packets of a transmission layer higher than an IP layer which performs a packet service and may process an application layer program. The upper layer processing unit 110 may include an application layer program executing unit 112 and a TCP/IP processing unit 114. The configuration and operation of the upper layer processing unit 110 is only explanatory, and may vary in configuration and operation.

The physical interface unit 130 may include multiple physical interfaces 132 and 134 for access to the multiple networks. Although in the example illustrated in FIG. 1 the mobile node 10 includes two physical interfaces, the type and number of the physical interfaces may not be limited thereto. For example, the physical interface unit 130 may include a wireless LAN access interface, worldwide interoperability for microwave access (WiMAX) interface, a 3^{rd} generation partnership project (3GPP) access interface, and the like. In FIG. 1, a first physical interface 132 may be connected to the Internet 50 through the first access network 30, and the second physical interface 134 may communicate with the correspondent node 20 through the second access network 40.

Generally, the first physical interface 132 and the second physical interface 134 may be, respectively, allocated IP addresses to enable the mobile node 10 to communicate with the correspondent node 20. However, in the example of the present invention, the logical interface unit 120 may allocate a single home IP address to the multiple physical interfaces 132 and 134, and the upper layer processing unit 110 processes packets using the single home IP address. The single home IP address refers to an address of the logical interface unit 120. Thus, the correspondent node 20 may transmit a packet having the home IP address of the logical interface 120 set as a destination address to the mobile node 10 regardless of an access type, and the mobile node 10 may transmit a packet while maintaining a session with the correspondent node 20 using the single home IP address. Here, the session may refer to maintaining of a flow that uses a current source address, a destination address, a source port, a destination port, and protocol.

For example, the correspondent node 20 may set its own address B as a source address, and transmit a packet having the address A of the logical interface 120 as a destination address. In the first access network 30, binding information of identification information of the first physical interface 132 of the mobile node 10 and the address A of the logical interface unit 120 may be set in advance. Thus, the first access network 30 may transmit a packet which has the address A received from the correspondent node as a destination address to the first physical interface 132 using the binding information. When the packet having the address A as a destination address arrives at the second access network 40, the second access network 40 may transmit the packet to the second physical interface 134 of the mobile node 10 in a similar way to the first access network 30.

When the packet having the address A as a destination address arrives at either the first physical interface 132 or the second physical interface 134 of the mobile node 10, the first physical interface 132 or the second physical interface 134 may transfer the packet to the logical interface unit 120. The logical interface unit 120 may transfer the arriving packet to the upper layer processing unit 110, and the upper layer processing unit 110 may process the transferred packet.

The logical interface unit 120 may process packets belonging to the same session to be transmitted and received through the same physical interface belonging to the physical interface unit 130 including the multiple physical interfaces 132 and 134. Hence, when handover from the first access network 30 to the second access network 40 occurs while a session is established between the first physical interface 132 and the first access network 30, the upper layer processing unit 110 may perform a packet service while maintaining the session using the single home IP address.

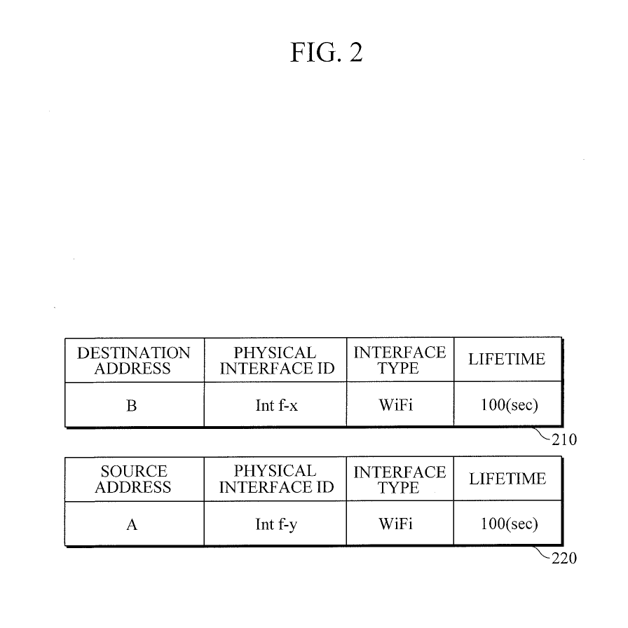

The physical interface unit 120 may manage a session mapping table (not illustrated) including session mapping information that indicates a mapping relationship of each session to physical interfaces so as to enable packets belonging to the same session to be transmitted and received through the same physical interface. In the case of a session with transmission packets transmitted from the upper layer processing unit 120, the session mapping information may be information that maps each of the physical interfaces to each destination address of the transmission packets. Alternatively, in the case of a session with reception packets received through the physical interface unit 130, the session mapping information may be information that maps each of the physical interfaces to each source address of the reception packets. An example of the session mapping table is illustrated in FIG. 2.

FIG. 2 illustrates tables of an example of a session mapping table.

The session mapping table 210 may include session mapping information of mapping between physical interfaces and each destination address of transmission packets. The session mapping table 210 may include a destination address of a transmission packet, identifier (ID) information of a physical interface through which the transmission packet is transmitted, and a type (e.g., WiFi, WiMAX, 3GPP, or the like) and lifetime of the session mapping information.

In another example, the session mapping table 220 may include session mapping information of mapping between physical interfaces and each source address of reception packets. The session mapping table 220 may include a source address of a reception packet, identifier (ID) information of a physical interface through which a reception packet is received, and a type and lifetime of the session mapping information.

In FIG. 2, for convenience of explanation, two session mapping tables 210 and 220 are separately illustrated, but they may be configured in an integrated manner.

Referring to FIG. 1 again, the logical interface unit 120 may search for a destination address of the transmission packet input through the higher layer processing unit 110 from the session mapping table 210, and, if the destination address is not found in the session mapping table, may generate session mapping information regarding the transmission packet and add the generated session mapping information to the session mapping table 210. In addition, the logical interface unit 120 may search for a source address of the reception packet received through the physical interface unit 130 from the session mapping table 220. If the source address of the reception packet is not found in the session mapping table 220, the logical interface unit 120 may generate session mapping information regarding the reception packet and add it to the session mapping table 220. The logical interface unit 120 may delete session mapping information from the session mapping table 210 and 220 when lifetime (for example, 100 seconds) of the session mapping information which is included in the lifetime information is expired.

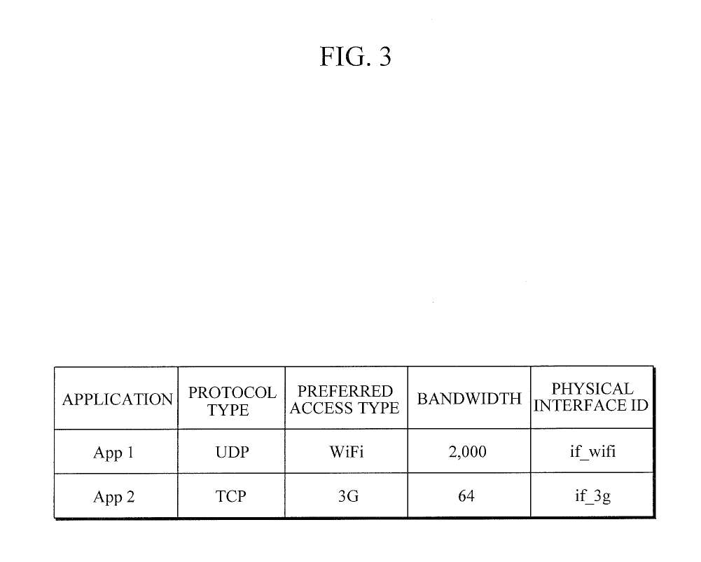

Moreover, the logical interface unit 120 may determine whether to forward a packet that is transferred in response to a call of the application layer program executing unit 112 to the first physical interface 132 or the second physical interface 134, and may generate a packet using a source address A and transmit the packet to the correspondent node 2. The logical interface unit 120 may determine a physical interface of the packet transferred from the upper layer processing unit 110 in consideration of load balancing. Alternatively, the logical interface unit 120 may determine a physical interface for the transferred packet using information of an application policy profile table 300 as shown in an example illustrated in FIG. 3.

FIG. 3 illustrates an example of an application policy profile table.

The logical interface unit 120 may manage the application policy profile table 300 that includes profile information required for the logical interface unit 120 to operate. The application policy profile table 300 may show transfer protocol and a preferred type of physical interface of each service or application. The logical interface unit 120 may use information contained in the application policy profile table 300 to determine a type of the physical interface for the packet transferred from the upper layer processing unit 110.

The application policy profile table 300 may include application identifier (ID) information, a protocol type, a preferred access type, a desired bandwidth and physical interface ID information. The application ID information is information assigned to each service or application for identification purpose. The protocol type is a type of protocol of a transmission layer such as UDP or TCP. The preferred access type is a type of access network that is preferred by each application or service. The preferred access type is information that indicates which access network is to be used to execute an application among the multiple interfaces, and that may be delivered through policies or a real-time user instruction. The bandwidth field may be used to specify a minimum bandwidth required by each application. The bandwidth field may be used as reference information for load balancing. The physical interface ID information may refer to a name of an actual output interface among the multiple interfaces.

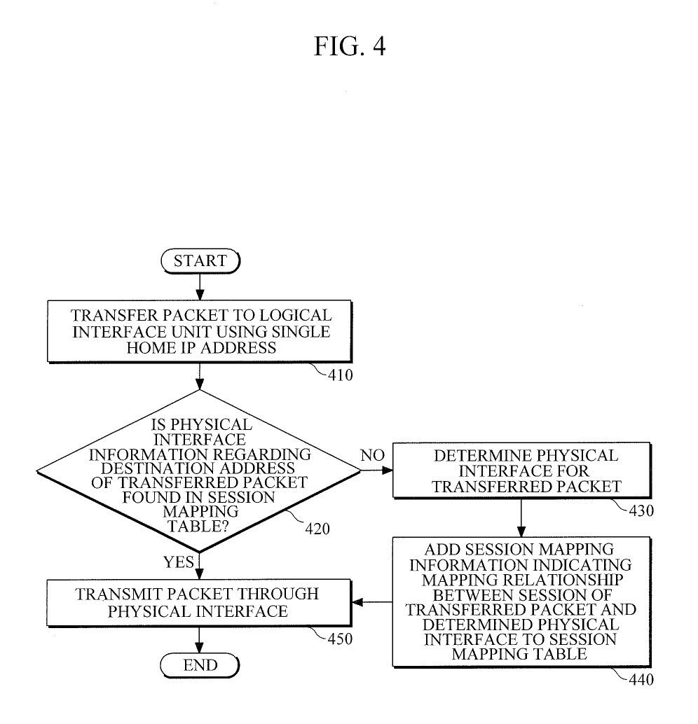

FIG. 4 illustrates a flowchart of an example of procedures of processing a packet transferred from an upper layer processing unit that executes an application.

The upper layer processing unit that executes a packet transfers the packet to a logical interface unit using a single home IP address in operation 410.

The logical interface unit searches for physical interface information with respect to a destination address of the transferred packet from a session mapping table that includes session mapping information indicating a mapping relationship of each session to the physical interfaces in operation 420.

When the physical interface information with respect to a destination address of the transferred packet is found in operation 420, the packet is transmitted through a physical interface that corresponds to physical interface information, from among multiple physical interfaces for access to multiple wireless networks in operation 450.

When the physical interface information with respect to a destination address of the transferred packet is not found in operation 420, a physical interface for the packet is determined in operation 430. Session mapping information that indicates a mapping relationship between a session of the transferred packet and the determined physical interface is added to the session mapping table in operation 440.

The packet transferred from the upper layer processing unit is transmitted through the determined physical interface in operation 450.

The determination of the physical interface for the packet transferred from the upper layer processing unit may be performed using an application policy profile table showing transfer protocol and information of a preferred physical interface of each service or application. Alternatively, the determination of the physical interface of the packet transferred from the upper layer processing unit may be performed in consideration of load balancing between the physical interfaces. If a physical interface determined based on the application policy profile table or a physical interface determined by a load balancing algorithm is not available, a default physical interface may be used for packet transmission. In FIG. 3, the session mapping table is used prior to the application policy profile table, but the application policy profile table may be used first to recognize a physical interface preferred by a corresponding application.

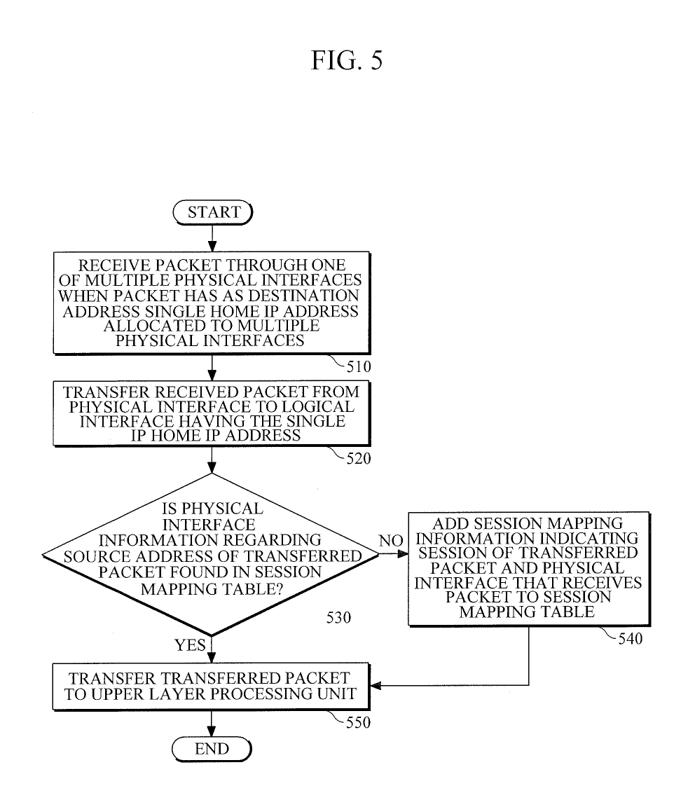

FIG. 5 illustrates a flowchart of an example of procedures to be processed by a logical interface for a packet received through a physical interface from a correspondent node.

A packet that has as a destination address a single home IP address allocated to multiple physical interfaces is received through a physical interface from among the multiple physical interfaces for access to multiple wireless networks in operation 510.

The physical interface transfers the received packet to the logical interface having a single home IP address in operation 520.

The logical interface unit searches for physical interface information related to a source address of the transferred packet from a session mapping table which includes session mapping information of each physical interface in operation 530.

When the physical interface information related to the source address of the transferred packet is found in operation 530, the transferred packet is transferred to an upper layer processing unit to perform a packet service in operation 550. When the physical interface information related to the source address of the transferred packet is not found in operation 530, session mapping information that indicates a mapping relationship between a session of the transferred packet and the physical interface through which the packet has been received is added to the session mapping table in operation 540. Thereafter, the transferred packet is transferred to the upper layer processing unit that performs a packet service in operation 550.

Since a logical interface having a single home IP address is used in an effort to maintain a session in a mobile node, there is no change in the home IP address even when a handover occurs in a physical interface layer, and thus a seamless packet service can be provided in the upper application layer. Moreover, the logical interface may transfer packets for the same session to the same physical interface based on session connection information, so that an order of packets can be conserved in the session.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A mobile node comprising:
an upper layer processing unit configured to perform a packet service;
a physical interface unit configured to comprise multiple physical interfaces for access to multiple wireless networks; and
a logical interface unit configured to allocate a single home Internet protocol (IP) address to the multiple physical interfaces and enable the upper layer processing unit to process a packet using the single home IP address, and to process packets belonging to the same session to be transmitted and received through the same physical interface from among the multiple physical interfaces.

2. The mobile node of claim 1, wherein the logical interface unit is further configured to manage a session mapping table that includes session mapping information indicating a mapping relationship of each session to the physical interfaces in an effort to process the packets belonging to the same session to be transmitted and received through the same physical interface.

3. The mobile node of claim 1, wherein with respect to a session of a transmission packet which has the home IP address as a source address and is transferred from the upper layer processing unit, the session mapping information is information that maps the physical interface to a destination address of the transmission packet, and with respect to a session of a reception packet which has the home IP address as a destination address and is received through the physical interface unit, the session mapping information is information that maps the physical interface to a source address of the reception packet.

4. The mobile node of claim 3, wherein the information that maps the physical interface to the destination address of the transmission packet includes the destination address of the transmission packet, identifier information of a physical interface for transmitting the transmission packet, and a type of the physical interface, and the information that maps the physical interface to the source address of the reception packet includes the source address of the reception packet, identifier information of a physical interface for receiving the reception packet, and a type of the physical interface.

5. The mobile node of claim 4, wherein the logical interface unit is further configured to search for the destination address of the transmission packet, which is input through the upper layer processing unit, from the session mapping table, and, if the destination address of the transmission packet is not found in the session mapping table, generate session mapping information regarding the transmission packet and add the generated session mapping information to the session mapping table.

6. The mobile node of claim 4, wherein the logical interface unit is further configured to search for the source address of the reception packet, which is received through the physical interface unit, from the session mapping table, and, if the source address of the reception packet is not found in the session mapping table, generate session mapping information regarding the reception packet and add the generated session mapping information to the session mapping table.

7. The mobile node of claim 4, wherein the session mapping information further includes lifetime information and the logical interface unit is further configured to delete session mapping information from the session mapping table when lifetime of the session mapping information that is included in the lifetime information has expired.

8. The mobile node of claim 1, wherein the logical interface unit is further configured to further comprise an application policy profile table that shows transfer protocol and a preferred type of physical interface of each service or application, a physical interface for the packet transferred from the upper layer processing unit is determined using the application policy profile table.

9. The mobile node of claim 8, wherein the application policy profile table includes application identifier information, a protocol type, a preferred type of physical interface, bandwidth, and physical interface identifier information.

10. A packet processing method comprising:
transferring, at an upper layer processing unit, a packet to a logical interface unit using a single home IP address;
searching for, at the logical interface unit, physical interface information regarding a destination address of the transferred packet from the session mapping table that includes session mapping information indicating a mapping relationship of each session to physical interfaces; and
when the physical interface information regarding the destination address of the transferred packet is found, transmitting the packet through a physical interface corresponding to the found physical interface information from among multiple physical interfaces for access to multiple wireless networks.

11. The packet processing method of claim 10, when the physical interface information regarding the destination address of the transferred packet is not found, further comprising:
determining a physical interface for the packet transferred from the upper layer processing unit;
adding session mapping information indicating a mapping relationship between a session of the transferred packet and the determined physical interface to the session mapping table; and
transmitting the transferred packet through the determined physical interface.

12. The packet processing method of claim 11, wherein the session mapping information includes information that maps a physical interface to the destination address of the transferred packet.

13. The packet processing method of claim 11, wherein the determining of the physical interface for the packet transferred from the upper layer processing unit comprises determining the physical interface for the transferred packet using an application policy profile table that shows transfer protocol and preferred physical interface information of each service or application.

14. The packet processing method of claim 11, wherein the determining of the physical interface of the packet transferred from the upper layer processing unit comprises determining the physical interface of the transferred packet in consideration of load balancing between the multiple physical interfaces.

15. The packet processing method of claim 10, wherein when handover from a first access network to a second access network occurs while a session connection is established with the first access network, further comprising continuously performing, at the upper layer processing unit, a packet service using the single home IP address.

16. A packet processing method comprising:
receiving a packet through one of multiple physical interfaces for access to multiple wireless networks wherein the packet has a single home IP address allocated to the multiple physical interfaces as a destination address;
transferring the received packet from the physical interface to a logical interface having the single home IP address;
searching for, at the logical interface unit, physical interface information regarding a source address of the transferred packet from session mapping table that includes session mapping information indicating a mapping relationship of each session to the physical interfaces; and
when the physical interface information regarding the source address of the transferred packet is found, transferring the transferred packet to an upper layer processing unit that performs a packet service.

17. The packet processing method of claim 16, when the physical interface information regarding the source address of the transferred packet is not found, further comprising:
adding session mapping information to the session mapping table wherein the session mapping information indicates a mapping relationship between a session of the transferred packet and the physical interface through which the packet is received.

18. The packet processing method of claim 16, wherein the session mapping information maps the physical interface to the source address of the transferred packet.
